(19) United States
(12) Patent Application Publication
(10) Pub. No.: US 2002/0010760 A1
(43) Pub. Date: Jan. 24, 2002

(54) Apparatus for and method of providing user notification and connectivity

(76) Inventors: Anthony Armenta, San Jose, CA (US); Craig Colvin, San Jose, CA (US)

Correspondence Address: DICKSTEIN SHAPIRO MORIN & OSHINSKY LLP, Eric Oliver, 2101 L Street NW, Washington, DC, 20037-1526, US

(21) Appl. No.: 09/833,707

(22) Filed: Apr. 13, 2001

Related U.S. Application Data
(60) Provisional application No. 60/196,929, filed on Apr. 13, 2000.

(51) Int. Cl. G06F 15/16

(52) U.S. Cl. 709/219; 709/203

(57) ABSTRACT

In accordance with a preferred embodiment, a system (and corresponding method) is provided for notifying users of relevant information, service, products, updates, or other topics of interest (e.g., selected Web sites) via a network (e.g., Internet) or the like. Users are provided with an ability to predetermine the subject matter or topics of interest, and be notified whenever information is to be conveyed to the user concerning the desired subject matter. Utilizing the unique system (and corresponding method), information or content providers (e.g., Web site owners) are able to notify all (or subgroups of) users over the network of information or content to be conveyed, as well as track and measure the effectiveness of the notification information in attracting and maintaining a user base for the provided information or content.

This application derives from and claims the benefit of U.S. Provisional Application No. 60/196,929, filed Apr. 13, 2000, which is incorporated herein by reference in its entirety.

### BACKGROUND

A number of known systems have been utilized in an attempt to provide users with information from sources (e.g., content providers, merchants, etc.) thought to be desired by the users. With the tremendous efficiencies recently achieved through technological development of the Internet and other communication networks, these sources have the ability to publish information on almost any topic or subject matter at a mere fraction of the cost of traditional media. With such efficiencies, the number of sources vying for attention in the current Internet space has increased exponentially such that a premium is placed on the ability to attract and retain attention of a solid base of users. A number of technologies have emerged in an attempt to facilitate this need for attracting and retaining users.

Push technologies such as those used by Pointcast, EntryPoint, and others have attempted to “push” content to individual users. Users selecting topics or categories of interest when connected to the Internet will be able to receive a continuous stream of updates regarding the desired topics. A content provider employing this technology aggregates (and often reformats) content for which the user can select the desired topics.

Offline browsing technology such as that employed in Microsoft Channels can also be used to retrieve content from sources (e.g., Web pages) selected by a user such that the user can view the content offline. Some systems allow users to “subscribe” to a particular Web page or channel, and poll the channel frequently for changes in the content. When a change is detected, the content is retrieved and stored locally for offline viewing by the subscribing user.

Web tracking technology such as that used by NetMind and Onscan, for example, allow users to select Web pages to be tracked for changes. Typically, Web tracking involves examining the HTML code of a desired Web page and other content on the page to detect changes. Once a change is detected, the user is notified via e-mail, specific client application, or some other mechanism (e.g., pager).

e-Syndication technology is another form of content aggregation. Systems like those used by iSyndicate and Headliner.net, for example, syndicate content (typically, headlines, articles, pictures) from various sources and make it available to Web sites. The content is continuously updated and “pulled” from the syndicator system by participating Web sites for viewing by their users.

### SUMMARY

In accordance with a preferred embodiment, a system (and corresponding method) is provided for notifying users of relevant information, services, products, updates, or other topics of interest (e.g., selected Web sites) via a network (e.g., Internet) or the like. Users are provided with an ability to predetermine or select the subject matter, topics of interest, and providers of the same, and be notified whenever information is to be conveyed to the user concerning the selections made. Utilizing the unique system (and corresponding method), information or content providers (e.g., Web site owners) are able to notify all (or subgroups of) users over the network of information or content to be conveyed, as well as track and measure the effectiveness of the notification information in attracting and maintaining a user base for the provided information or content.

### BRIEF DESCRIPTION OF DRAWINGS

FIG. 1 illustrates a system architecture in accordance with a preferred embodiment of the invention;

FIG. 2 illustrates a client device in accordance with a preferred embodiment of the invention;

FIGS. 3a and 3b illustrate operation of a client device in accordance with an exemplary commercial implementation of a preferred embodiment of the invention;

FIG. 4 illustrates an exemplary method of providing notification to a user in accordance with a preferred embodiment of the invention; and

FIG. 5 illustrates an exemplary method of receiving notification in accordance with a preferred embodiment of the invention.

### DETAILED DESCRIPTION

Preferred embodiments and applications of the invention will now be described. Other embodiments may be realized and structural or logical changes may be made to the disclosed embodiments without departing from the spirit or scope of the invention. Although the preferred embodiments disclosed herein have been particularly described as applied to a system for (and corresponding method of) providing notification information related to content to be provided to a user over an external network (e.g., Internet), it should be readily apparent that the invention may be embodied in any system (or method) having the same or similar problems.

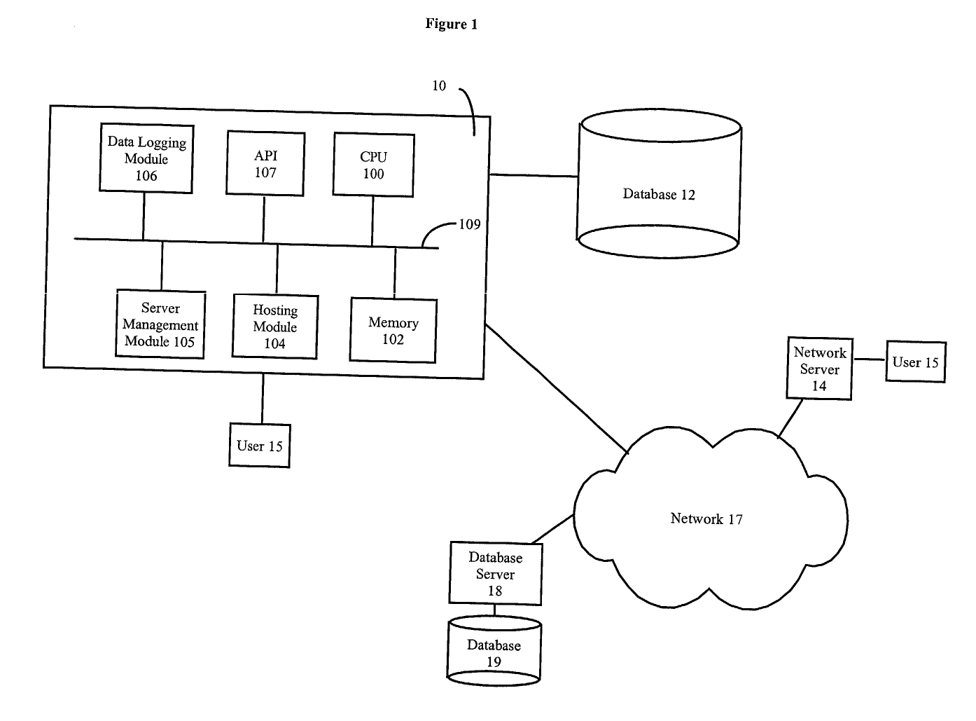

An exemplary system architecture in accordance with a preferred embodiment of the invention is illustrated in FIG. 1. The exemplary system architecture may be used to effectuate any one or more aspects of the notification and connection operations described in (and apparent from) the specific embodiments, implementations, illustrations, and other examples provided herein.

Some of the many system components that may be employed in the architecture include: one or more notification servers (symbolically depicted as “server 10”); one or more database units or subsystems (symbolically depicted as “database 12”); one or more remote database unit s (symbolically depicted as “database 19”); one or more networks (symbolically depicted as “network 17”); and one or more users or notification client devices (symbolically depicted as “user 15” or “user interface 15”), as will be described in more detail below.

In accordance with a preferred embodiment, server 10 may include one or more central processing units (CPUs) symbolically represented by CPU 100 used to provide processing of input/output data between server 10, user interface 15, and/or network 17, and among the different modules (all connected together via system bus 109) within server 10. CPU 100, which may be any known processor or processor-based system, typically executes one or more executable instructions or programs stored in the one or more (local or remote) memory devices (or other articles of manufacture) symbolically represented as memory module 102. Individual control modules (e.g., hosting module 104, server management module 105, server data logging module 106, application programmable interface module 107, etc.) may be provided to control processing of the individual notification and/or connection operations described in (or apparent from) the instant disclosure, as will be described in detail below. The individual control modules may themselves be processors or processor-based systems executing one or more executable programs (locally or remotely) stored in a memory component (or other article of manufacture).

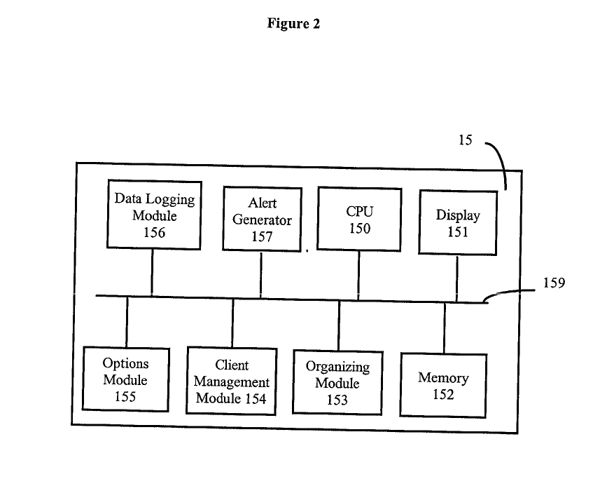

User interface 15 may include one or more display devices 151 (FIG. 2) (e.g., CRT, LCD, plasma, holographic, or other known displays) or other output devices (e.g., printer, etc.), and one or more input devices (e.g., keyboard, mouse, stylus, touch screen interface, or other known input mechanisms) for facilitating interaction of a user with the system via user interface 15. As illustrated, user interface 15 may be directly coupled to server 10, or indirectly coupled to server 10 through one or more interfacing modules (e.g., network server 14) and one or more direct or indirect transmission paths (e.g., symbolically represented as “network 17”).

Network 17 may take any wired/wireless form of known connective technology (e.g., corporate or individual LAN, enterprise WAN, intranet, Internet, Virtual Private Network (VPN), combinations of network systems, etc.) to allow server 10 to provide local/remote information and control data to/from other locations (e.g., remote database server 18/remote database 19, network server 14/user interface 15, etc.). In accordance with a preferred embodiment of the invention, server 10 may be implemented in stand-alone or network devices, as well as serving one or more users over a collection of remote and disparate networks (e.g., Internet, intranet, VPN, etc.).

In accordance with a preferred embodiment, user interface 15 may include (as shown in FIG. 2) one or more central processing units (CPUs) symbolically represented by CPU 150 used to provide processing of input/output data between user interface 15, server 10, and/or network 17, and among the different modules (all connected together via system bus 159) within user interface 15. CPU 150, which may be any known processor or processor-based system, typically executes one or more executable instructions or programs stored in the one or more (local or remote) memory devices (or other articles of manufacture) symbolically represented as memory module 152. Individual control modules (e.g., organizing module 153, client management module 154, options module 155, client data logging module 156, alert generator 157, etc.) may be provided to control processing of the individual notification and/or connection operations described in (or apparent from) the instant disclosure, as will be described in detail below. The individual control modules may themselves be processors or processor-based systems executing one or more executable programs (locally or remotely) stored in a memory component (or other article of manufacture).

In accordance with a preferred embodiment of the invention, information related to notifications of content to be provided to users may be stored in database 12 and/or in one or more remote database or storage systems (e.g., database 19). (For simplicity, reference is made herein only to database 12, although it should be readily apparent that one or more supplementary or alternative storage devices (e.g., remote database 19, memory module 102, etc.) may be employed in lieu of (or in combination with) database 12 for any given implementation of the invention.) In this exemplary embodiment, the stored information is related to notifications of content to be provided by content providers, including graphical, textual, and other sensory perceptual information (e.g., audio, Braille, or any information that may be viewed, heard, felt, or otherwise sensed by users). The notification information may be stored as a continuous set of data, segmented to form a contiguous whole, or separated into different segments to reside in and among one or more server databases, as well as partitioned for storage in one or more files to achieve efficiencies in storage, access, and processing of data. The notification information may be stored in (or otherwise converted into) any known format including known graphical (e.g., BMP, GIF, JPG, etc.), textual (e.g., ASCII, DOC, HTML, PDF, RTF, TIF, WAP, XML, etc.), as well as audio/visual (e.g., AVI, MP3, MOV, MPEG, WAV, etc.) formats that may be understood by diverse user components such as mainframe and personal computers, wireless and handheld devices, etc.

The notification information may further include identification information that identifies one or more destinations or resources that provide content desired to be offered to the user. The identification information may be, for example, interactive information such as a uniform or universal resource locator (URL) address (in HTML-format) of a Web site (e.g., owned by a content provider or third party), or simply static information such as the name, address, and contact information of the content provider (or others). The destination or resource (e.g., Web site) identified in the notification information may provide information or other content related to products, services, updates, news, or any topic of interest, or provide a source for documents, articles, streaming audio/video, or any other form of content (e.g., chat rooms, bulletin boards, links, etc.) desired to be offered or presented to a user.

In accordance with a preferred embodiment, in server 10, hosting module 104 is provided (alone or in conjunction with other modules) to enable content providers to provide notification information over one or more access channels to one or more users. In an exemplary embodiment, for example, hosting module 104 may be programmed to create one or more access channels (e.g., in the form of “wires”) for use by content providers (e.g., Web site owners) to send notifications (e.g., in the form of “blasts”) to users subscribing to, selecting, or otherwise agreeing to receive notification information (e.g., blasts) over associated wires. Hosting module 104 may be programmed to compile, delete, track, log, or otherwise make use of data (e.g., subscriber history, blast history, wire profiles, etc.) with respect to individual wires processed by server 10. Hosting module 104 may further be programmed to store, maintain, catalog, classify or categorize, and access wires in data storage (e.g., database 12).

In accordance with a preferred embodiment of the invention, server management module 105 is provided to implement (alone or in conjunction with other modules) management functions required to permit use of the system by content providers and subscribers, as well as process the blasts transmitted through the system. In an exemplary embodiment, for example, server management module 105 is programmed to permit creation, deletion, distribution, tracking, and logging of data pertinent to blasts processed by server 10.

Management module 105 may be further programmed to create, delete, maintain, and otherwise manage data records and accounts for content providers and subscribers of individual wires. In an exemplary embodiment, for example, management module 105 may be programmed to provide billing functions to content providers and/or subscribers (if applicable) for billable usage (e.g., per wire, per blast, etc.) of the system. Management module 105 may be used to record, store, and maintain wire subscriptions history, user profile data, and wire configuration data. Management module 105 may further be programmed to handle the access to the system resources. Management module 105, for example, may be programmed to process scheduling of blasts over one or more wires, targeting of blasts to individual subscribers of wires (e.g., based on user profiles, etc.), processing the various options assigned to blasts by content providers, balancing processing loads during peak periods, or redirecting communications to distributed servers.

In accordance with a preferred embodiment of the invention, a server data logging module 106 is provided to implement (alone or in conjunction with other modules) a variety of functions and operations related to recording, tracking, maintaining, and analyzing information and data related to the usage of the system at server 10 and at user interfaces 15. In an exemplary embodiment, for example, server data logging module 106 logs extensive wire/blast performance data so that content providers can measure the effectiveness of blasts, and see how users are interacting with their respective wires. Data logging module 106 may be programmed to permit periodic and/or real-time (i.e., “live” during operation of server 10 and/or user interface 15) review of raw data, summaries, and analysis of the data by content providers and other interested entities.

In accordance with a preferred embodiment of the invention, an application programming interface (API) 107 may be provided to facilitate access to the many features of server 10 by content providers, users, and others (e.g., Web sites, etc.).

In accordance with a preferred embodiment of the invention, user interface 15 (shown in detail in FIG. 2) may be provided with organizing module 153 that implements (alone or in conjunction with other modules) the collection, organization, and offering of wires to users. In an exemplary embodiment, for example, organizing module 153 may be programmed to present or display wires on a window or the like of a display screen 151 of user interface 15. Organization module 153 may respond to user inputs to organize selected wires into one or more category channels (e.g., favorites, hobbies, bargains, books, etc.). To facilitate scanning of blasts received on individual wires, organizing module 153 may present the category channels with blast indicators to inform a user of new blasts received within a given category channel.

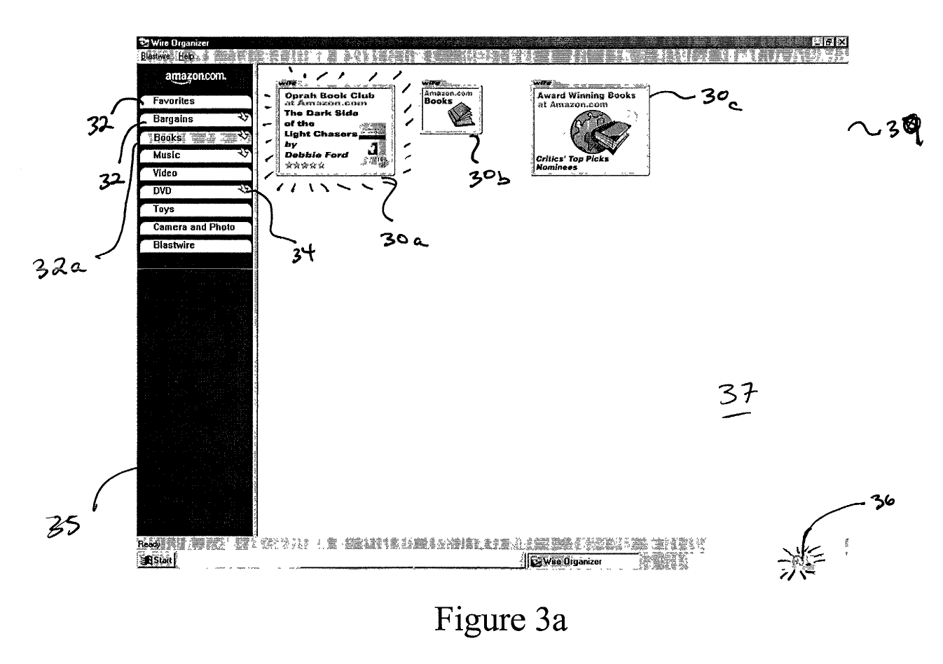

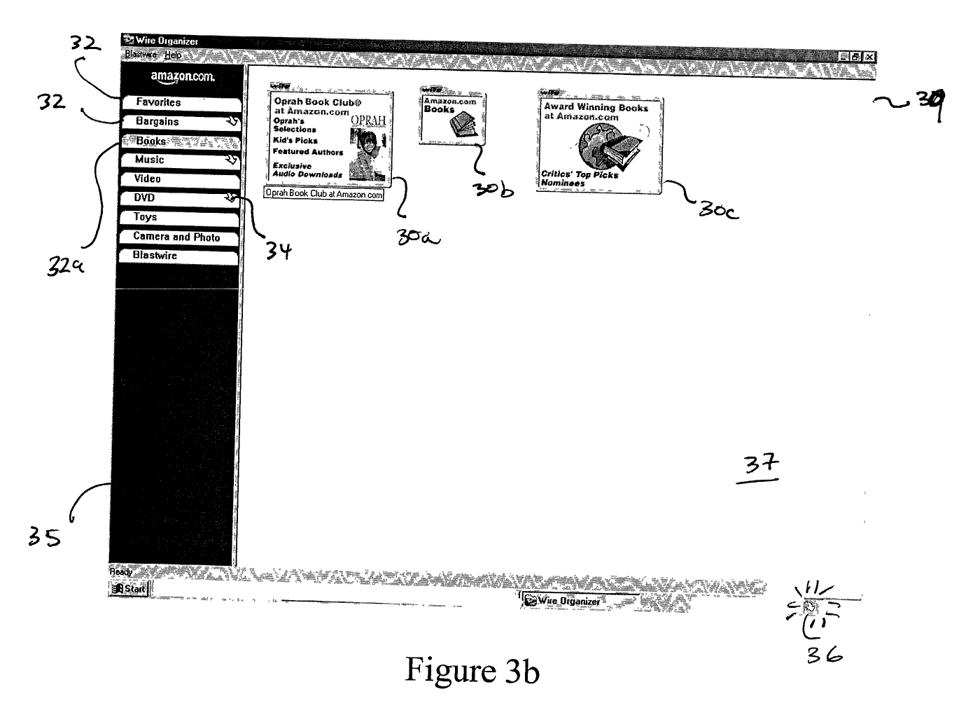

An exemplary use of organizing module 153 in the exemplary commercial implementation of an embodiment of the invention known as the “BlastWire” network (described in the EXAMPLE section below) is illustrated in FIGS. 3a and 3b, where wires 30a, 30b, 30c may be presented in a display window frame 37 of a display window 39 of user display 151. Wires 30a, 30b, 30c have been grouped together under the selected category channel “books” (32a) based on user inputs. A number of category channels 32 are presented in a window sidebar 35 for selection by the user. Blast indicators 34 are shown on category channels 32 having new blasts. In the selected “books” category 32a, wire 30a is highlighted to illustrate the presence of a new blast. Wires 30b, 30c are shown with default wire images, as no new blasts have been sent over these wires. After activation of the new blast (or issuance of an “ignore blast” command), wire 30a returns to its default state (e.g., displaying default notification information in the form of a default image on the wire icon in the display window), as shown in FIG. 3b.

Client management module 154 is provided to implement (alone or in conjunction with other modules) management functions necessary to utilize the wires and blasts processed by the user interface 15. In an exemplary embodiment, for example, client management module 154 is programmed to facilitate the process of subscribing (or canceling subscriptions) to individual wires. Where needed, synchronization of subscription information is made between user interface 15 and server 10. The synchronization may further include the removal of blasts or prevention of offering of blasts that have been cancelled by their content provider, or blasts that have expired based on time limits placed by the user or content provider. Wires having cancelled or expired blasts revert to their default offering states (e.g., default wire image, default destination, etc.).

In accordance with a preferred embodiment, client management module 154 is further programmed to facilitate transfer of blasts from server 10. In an exemplary embodiment, for example, client management module 154 is programmed to initiate a blast request, periodic polling request, or other request to server 10 for any blasts that may be applicable to user interface 15 (e.g., blasts for wires subscribed to by a user). Applicable blasts may be downloaded from server 10 as a background function and cached locally in user interface 15 to provide a faster user experience. Client management module 154 is also programmed to address network loading issues in conjunction with server 10 so as to provide load balancing during peak periods or redirection of communications to distributed servers.

In accordance with a preferred embodiment, an options module 155 is provided to implement (alone or in conjunction with other modules) recording and reporting of input user information that may facilitate or customize the use of the system. In an exemplary embodiment, for example, users may input user information about optional features of specific wires, or personal profile, preference, demographic, or other personalized information (e.g., restriction to family rated blasts, etc.). This input user information can be provided to server 10 and used by content providers and/or server 10 to better target blasts to individual subscribers, and prevent unwanted blasts.

In accordance with a preferred embodiment, a client data logging module 156 may be provided to implement (alone or in conjunction with other modules) the collection and logging of extensive information regarding user interaction with wires and blasts. In an exemplary embodiment, for example, client data logging module 156 may be programmed to detect and record data such as the activation (e.g., “click-throughs”) of blasts/wires, blasts ignored, subscriptions to wires, cancellations of subscriptions to wires, etc. Client data logging module 156 may be programmed to transmit to server 10 (or other modules or systems) the raw data accumulated for on-demand or periodic delivery, as well as transmit the data on a real-time (“live”) basis, or perform analysis of the data prior to transmission.

In accordance with a preferred embodiment, an alert generator module 157 may be provided to implement (alone or in conjunction with other modules) user alert functions to inform the user that one or more blasts have been received or are active. In an exemplary embodiment, for example, alert generator module 157 may be programmed to display a flashing icon (e.g., task bar icon 36, FIG. 3a) on the display of the user interface, provide specialized sounds, pop-up alerts, or other sensory perceptual information to inform or otherwise alert the user of the presence of new and/or active blasts.

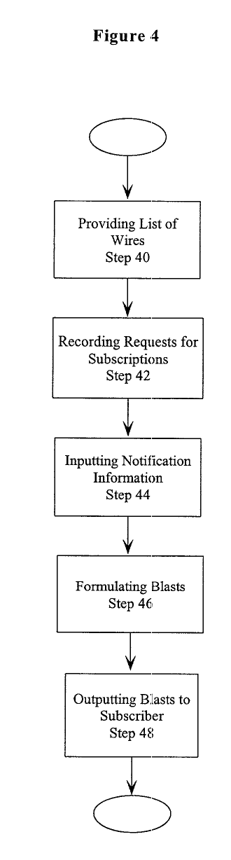

A method of notifying a user of content to be provided to the user in accordance with a preferred embodiment of the invention is illustrated in FIG. 4. The illustrated method may be derived from (or implemented by) one or more of the exemplary embodiments described above. In accordance with this exemplary method, a list of available access channels or wires is provided (step S40) to users. The list of wires may, for example, be provided through use of a Web site that provides a directory server of available wires individually assigned to or classified into different categories, provides various listings of wires (e.g., indexed by content provider, title, subject, date, etc.), or that provides a search engine for querying a database of wires based on keyword (or other) searches. Appropriate filtering mechanisms (e.g., ratings information accompanying wires indicating acceptable content for family, adults only, etc.) may be employed in the notification client and/or notification server to limit the types of wires/blasts that may be listed, searched, retrieved, or subscribed to by certain users (e.g., children).

User requests for subscription or other input selection information of individual access channels or wires is recorded (step S42). A subscription list of users subscribing to individual blasts can thus be maintained for use in transmitting pertinent blasts to the different subscribing users.

A content provider desiring to notify users of content to be provided to subscribing users inputs notification information (e.g., blast images, destination URLs, etc.) pertinent to a given blast (step S44). Access to the same or similar Web site, for example, may be provided to facilitate the input of notification information and creation of blasts. Based on the input information from the content provider, one or more blasts are formulated (step S46) and readied for transmission to subscribers.

The blasts thus formulated are then output or otherwise presented to subscribing users (step S48). In accordance with a preferred embodiment, the blasts may be output in response to polling or other requests by users (or user interfaces) for blasts on currently subscribed wires. The blasts may be communicated through direct connection to a client device of a subscriber (e.g., user interface 15), through indirect connection (e.g., via network 17 to user interface 15), or through any other known transmission path.

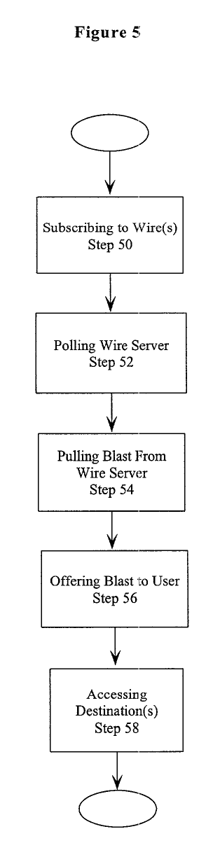

A method of receiving notification information of content to be provided to a user in accordance with a preferred embodiment of the invention is illustrated in FIG. 5. The illustrated method may be derived from (or implemented by) one or more of the exemplary embodiments described above. In accordance with this exemplary method, users desiring to be notified of content available from content providers (e.g., Web site owners, merchants, individuals, etc.) may subscribe to, select, or otherwise agree to receive such notification information from individual wires (step S50). The subscriptions may be available from the content provider itself, from a wire hosting server (or like system), from e-mail or other source. In an exemplary commercial implementation, a content provider's wire is promoted through identification (e.g., URL) of a subscription destination (e.g., subscription Web page) for which potential subscribers can access to subscribe to the content provider's wire.

After subscribing to one or more wires, polling or other requests are made by the user (e.g., through user interface 15) to a wire server (or other wire hosting system) for available blasts corresponding to subscription wires (step S52). When the hosting system grants the blast request for an individual (or group) of wires, the user (e.g., through user interface 15) “pulls” or downloads one or more blasts corresponding to the wires subscribed to by the user (step S54).

The blasts downloaded are then offered to the user (step S56). In accordance with a preferred embodiment, the blasts may be offered by presenting them for display on a display window or screen of a client device (e.g., user interface 15), together with one or more additional wires/blasts. Activation of a wire/blast initiates user access of a destination associated with the wire/blast (step S58). In an exemplary commercial implementation of an embodiment, the notification information of a given blast contains identification (e.g., URL) of a destination resource (e.g., Web site). Activation of the blast causes the user interface to access the destination resource to result in the offering of desired content (e.g., product information from a manufacturer's product server, article from a document server, audio/video stream from a media server, etc.) to the user. In accordance with a preferred embodiment, after a blast is activated (or if no blast is issued), activation of a wire results in access of a default destination resource previously associated with the wire by content provider (or other owner of the wire).

### EXAMPLE

As an illustration of an exemplary commercial implementation of an embodiment of the invention, a subscription, notification, and reconnection network known as the “BlastWire” network is summarized herein. A detailed description of the BlastWire network is provided in the Appendix of U.S. Application No. 60/196,929, filed Apr. 13, 2000, which is incorporated herein by reference in its entirety. In this exemplary implementation, the content providers are referred to as “Wire Owners” sending notification information in the form of “Blasts” to Web users who subscribe to one or more “Wires” serviced by the BlastWire network through one or more Web sites. A client-side notification software application referred to as a “Wire Organizer” is used to facilitate the reception, organization, and operation of Blasts and Wires. Users can easily collect or subscribe to wires by simply dragging wire indicia (e.g., image icons or other representations) from a subscription Web page (or other source) and dropping the wire indicia into the Wire Organizer desktop. Where a user cannot gain access to its regular user interface containing the Wire Organizer, a Web-enabled client device gaining access to the BlastWire network Web site can remotely view the blasts.

The BlastWire network minimizes the burden on the client-side host system by employing one or more optimization algorithms such as the BlastWire Load Balancing Algorithm. Communications sessions and synchronization levels used between clients and the server minimize redundant and wasteful transmissions. Transferring data via HTTP protocols and the like help eliminate problems with firewalls.

In the illustrative embodiment, the client device initializes all communications between the client device and the servers (known as “Wire Servers”) in the BlastWire network used to service the Wires. The client device may periodically send a communication request to a Wire Server. In response to the request, the Wire Server can send data in the form of information or commands directed to the Client device to perform particular actions. Any number of actions may be available (e.g., uploading click-through statistics, sending new subscription data, downloading Wire data, etc.).

While preferred embodiments of the invention have been described and illustrated, it should be apparent that many modifications to the embodiments and implementations of the invention can be made without departing from the spirit or scope of the invention. For example, while a client-server architecture has been specifically illustrated herein, the invention may easily be deployed in any form of network or communication technology. The functions and operations of server 10, as described herein, may be distributed into one or more server (or other processor-based structures). The function of managing of creation, maintaining, and tracking of wires and blasts, for example, may be provided by a single notification server, while the delivery of blasts to individual users may be distributed to another (or a plurality of other) server systems.

While the illustrated embodiments have not specified the type of communication medium (or protocol) used to connect the various modules and components (e.g., shown in FIG. 1), it should be apparent that any known wired/wireless technology may be used to implement the invention (e.g., Internet, intranets, private bulletin boards, individual local or wide area networks, proprietary chat rooms, ICQ, IRC channels, instant messaging systems, WAP, bluetooth, etc.) using real-time or non-real-time systems alone or in combination. The embodiments described in (or apparent from) the instant disclosure may be employed in stand-alone (or network linked) systems. The embodiments may similarly be implemented in other known systems and platforms (e.g., personal computer, Internet-based devices, PDAs, portable or hand-held electronic devices, etc.).

In accordance with a preferred embodiment, one or more user interfaces (e.g., user interface 15 (FIG. 1)) are provided as part of (or in conjunction with) the illustrated systems to permit users to interact with the systems. User interface devices may be any device used to input and/or output information. The user interface device may be implemented as a graphical user interface (GUI) containing a display or the like (as shown in FIG. 2), or may be a link to other user input/output devices known in the art. Individual ones of a plurality of devices (e.g., network/stand-alone computers, personal digital assistants (PDAs), WebTV (or other Internet-only) terminals, set-top boxes, cellular/PCS phones, screenphones, pagers, kiosks, or other known (wired or wireless) communication devices, etc.) may similarly be used to execute one or more computer programs (e.g., universal Internet browser programs, dedicated interface programs, etc.) to allow users to interface with the systems in the manner described.

The modules described herein, particularly those illustrated or inherent in the instant disclosure, may be one or more hardware, software, or hybrid components residing in (or distributed among) one or more local or remote computer systems. Although the modules may be shown or described herein as physically separated components, it should be readily apparent that the modules as described herein may be merely logical constructs that are implemented as physical components combined or further separated into a variety of different components, sharing different resources (including processing units, memory, clock devices, software routines, etc.) as required for the particular implementation of the embodiments disclosed herein.

The various modules described herein (e.g., API 107) may be replaced with one or more functionally same, similar, or equivalent components, or omitted altogether to rely on the capabilities of other system components to provide the same, similar, or equivalent functionality. Indeed, even a single general purpose computer (or other processor-controlled device) executing a program stored on an article of manufacture (e.g., recording medium or other memory units) to produce the functionality referred to herein may be utilized to implement the illustrated embodiments.

In addition, memory or database units described herein may be any one or more of the known storage devices or systems (e.g., Random Access Memory (RAM), Read Only Memory (ROM), hard disk drive (HDD), floppy drive, zip drive, compact disk-ROM, DVD, bubble memory, redundant array of independent disks (RAID), network accessible storage (NAS) systems, etc.), may also be one or more memory devices embedded within a CPU, or shared with one or more of the other components, and may be deployed locally or remotely relative to one or more components interacting with the memory or database units.

The illustrated embodiments have been described herein in connection with “content providers” (e.g., Web site owners/operators, merchants, sponsor, etc.) that desire to present content to users. It should be readily apparent, however, that the “content provider” as used in the above descriptions may refer to any entity, individual, or the like that desires to provide (commercial or noncommercial) information directly or indirectly to one or more users.

The “notification information” described herein can take any form such as text, graphics, animation, sound, or other form or format providing a preview of content to be viewed from a content provider or owner. The notification information may include one or more destination links (e.g., URLs) that operate to connect the client devices to one or more pages on the content provider's (or others') Web site. The system may include a database operative to facilitate monitoring (in real-time or non-real-time) and reporting on the delivery of and effective responses to the notification information to enable the content providers to gauge the interest in each notification.

Although not specifically mentioned, it should be readily apparent that server 10 (and other modules or components) described herein as accessing database 12 (or other remote database systems) may further include or be used in conjunction with search technology (e.g., spiders, worms, bots, or other known devices) used to access information in remote database systems (or other memory unit) over any internal or external network (e.g., the Internet) to perform the various functions of retrieving, accessing, searching, etc. for stored information.

The illustrated embodiments have further been described in connection with a “user”. It should be readily apparent that a “user” of the various aspects of the inventive systems or methods disclosed herein may be individuals, entities, devices, as well as peer/non-peer systems or technologies, and modules within the same device (e.g., server 10) or system without departing from the scope of the invention. The notification information or blasts output to the user have been described herein as being issued in response to polling or other requests made by the user (e.g., through user interface 15). It should be understood, however, that the notification information or blasts may alternatively be issued without polling or other requests being made by the user, or may be issued in response to any other event (internal or external to the system).

Accordingly, the invention is not to be limited by the foregoing description or drawings, and only by the claims appended hereto.

What is claimed is:

1. An article of manufacture having stored thereon an executable program operative to effectuate notification to a user by content owners desiring to provide content to the user, wherein the executable program is executed to perform the steps of:
(a) receiving input selection information corresponding to selected individual content owners of interest to the user;
(b) receiving a notification of content to be viewed from at least one selected content owner;
(c) presenting the notification received in said receiving step (b) to the user; and
(d) initiating access to at least one destination upon user activation of the notification presented in said presenting step (c).

2. The article of manufacture as recited in claim 1, wherein the input selection information received in said receiving step (a) is received from a directory server containing a database of individual content owners.

3. The article of manufacture as recited in claim 1, wherein said receiving step (b) further comprises the step of initiating communication with a hosting server to receive notifications of content to be viewed from content owners.

4. The article of manufacture as recited in claim 3, wherein the notification received in said receiving step (b) includes image data and an identification of an associated resource containing content to be viewed corresponding to the image data.

5. The article of manufacture as recited in claim 4, wherein the identification of an associated resource includes a uniform resource locator (URL) address of a destination resource available through the Internet.

6. The article of manufacture as recited in claim 3, wherein the notification received in said receiving step (b) contains textual information previewing content to be viewed from a corresponding content owner.

7. The article of manufacture as recited in claim 1, wherein said presenting step (c) includes displaying notifications received in said receiving step (b) as a plurality of individual image icons on a display window respectively corresponding to notifications received.

8. A system for providing notification by content owners desiring to provide content to a user, the system comprising:
a notification server comprising:
a hosting module, wherein said hosting module provides access channels to content owners desiring to provide content to users; and
a server management module, wherein said server management module provides over the access channels notifications to users of content to be provided by content owners.

9. The system for providing notification by content owners desiring to provide content to a user as recited in claim 8, the system further comprising:
a notification client comprising:
an organizing module, wherein said organizing module stores and organizes user selections of access channels to be used in receiving notifications from said notification server; and
a client management module, wherein said client management module initiates communication with said notification server, and retrieves notifications over the access channels selected by the user based on user selections stored by said organizing module.

10. The system for providing notification by content owners desiring to provide content to a user as recited in claim 9, wherein said notification server further comprises an application programmable interface (API), wherein said API outputs notifications to said notification client over the access channels.

11. The system for providing notification by content owners desiring to provide content to a user as recited in claim 9, wherein said notification server further comprises a data logging module, wherein said data logging module collects and logs notification interaction information from said notification server and said notification client.

12. The system for providing notification by content owners desiring to provide content to a user as recited in claim 8, the system further comprising a database subsystem, wherein said notification server stores in said database subsystem notifications created by content owners, and said notification server accesses said database subsystem when providing the notifications to users.

13. A method of receiving notification to users that have subscribed to individual wires of received blasts corresponding to the individual wires, wherein the wires are associated with respective content providers desiring to provide content to subscribing users, and wherein the blasts are notifications of the content to be provided to the users as desired by respective content providers, the method comprising the steps of:
(a) subscribing to at least one wire of a plurality of wires available for selection by a user;
(b) when connected to an external network in the form of the Internet, polling periodically at least one wire server resident on the external network for blasts corresponding to the at least one subscription wire, and pulling from the at least one wire server a blast corresponding to the at least one subscription wire;
(c) in a client device running a notification software application, offering the blast to a user on a user interface of the client device, wherein said offering step (c) comprises presenting the blast as information including at least one of graphical, textual, and sensory perceptual information to be perceived by the user; and
(d) accessing at least one destination resource on the external network upon activating the blast offered in said offering step (c), wherein the blast further includes a uniform resource locator (URL) address associated with the at least one destination resource, and wherein the at least one destination resource accessed in said accessing step (d) contains content desired by the content provider to be provided to the user.

14. The method of receiving notification to users as recited in claim 13, wherein said subscribing step (a) comprises accessing a Web site on the Internet containing at least one wire, displaying a Web page containing a wire image of the wire on a user interface, and dragging and dropping the at least one wire into a display window on the user interface by the notification software application.

15. The method of receiving notification to users as recited in claim 13, wherein the blasts are notifications in the form of previews of content on a destination resource that may be accessed by the user.

16. The method of receiving notification to users as recited in claim 13, wherein said polling step (b) further comprises preventing the offering of blasts that have been cancelled by their associated content providers, and preventing the offering of blasts that have expired.

17. A method of providing notifications in the form of blasts to users that have subscribed to individual wires, wherein the wires are associated with respective content providers desiring to provide content to subscribing users, and wherein the blasts are notifications of the content to be provided to the users as desired by respective content providers, the method comprising the steps of:
(a) providing a listing of a plurality of wires available to users for subscription, wherein the plurality of wires includes a first wire;
(b) recording user requests to subscribe to individual ones of the plurality of wires, wherein the user requests include a request by a first user for subscription to the first wire;
(c) inputting from content providers associated with individual ones of the plurality of wires notification information of the content to be provided to users subscribing to respective wires, said inputting step including input by a first content provider associated with the first wire
(d) formulating individual blasts from the notification information input by the content providers, wherein a first blast is formulated from the notification information input from the first content provider in said inputting step (c); and
(e) outputting individual blasts to subscribing users in response to requests for blast information from respective subscribing users, wherein said outputting step includes outputting the first blast to the first user in response to a request from the first user for blast information.

18. The method of providing notifications in the form of blasts to users as recited in claim 17, wherein said providing step (a) further comprises the step of classifying the plurality of wires into individual ones of a plurality of categories, and providing different categories of wires to users seeking to subscribe to ones of the plurality of wires.

19. The method of providing notifications in the form of blasts to users as recited in claim 17, wherein said providing step (a) further comprises the step of storing the plurality of wires, and providing a search engine for displaying individual ones of the plurality of wires based on search queries issued to the search engine.

20. The method of providing notifications in the form of blasts to users as recited in claim 17, wherein the notification information in the first blast includes a uniform resource locator (URL) address of content to be provided to users subscribing to the first wire.

21. The method of providing notifications in the form of blasts to users as recited in claim 20, wherein the URL address in the notification information in the first blast is the URL address of the content provider's Web site.

22. The method of providing notifications in the form of blasts to users as recited in claim 20, wherein the URL address in the notification information in the first blast is an address of a media server that provides streaming audio/video information.

23. The method of providing notifications in the form of blasts to users as recited in claim 17, wherein said outputting step (e) further comprises outputting default notification information upon cancellation of the first blast by the content provider.

24. The method of providing notifications in the form of blasts to users as recited in claim 17, wherein said outputting step (e) further comprises outputting default notification information upon expiration of the first blast.

25. The method of providing notifications in the form of blasts to users as recited in claim 17, further comprising:
(f) tracking the response to blasts output to individual users respectively subscribing to individual wires.
